(19) United States
(12) Patent Application Publication
(10) Pub. No.: US 2026/0300433 A1
(43) Pub. Date: Oct. 1, 2026

(54) COMPUTER, TIME EVOLUTION PATH GENERATION METHOD, AND TIME EVOLUTION PATH GENERATION PROGRAM

(71) Applicant: Hitachi, Ltd., Tokyo (JP)

(72) Inventors: Taiki MORINAGA, Tokyo (JP); Akinori ASAHARA, Tokyo (JP); Koichiro YAWATA, Tokyo (JP)

(21) Appl. No.: 19/541,993

(22) Filed: Feb. 17, 2026

(30) Foreign Application Priority Data
Mar. 31, 2025 (JP) 2025-059021

(51) Int. Cl. G06F 17/18

(52) U.S. Cl. CPC G06F 17/18

(57) ABSTRACT

A computer generates a first time evolution path based on a time evolution model and calculation condition parameters designating calculation conditions for a time evolution path and sampled from a prior probability distribution of the calculation condition parameters. Then, the computer calculates a posterior probability distribution of the calculation condition parameters in a case where a target statistic based on the first time evolution path and a second time evolution path to be newly generated is a correct statistic. The computer generates the second time evolution path based on the calculation condition parameters sampled from the posterior probability distribution and the time evolution model such that an error between the correct statistic and the target statistic based on the second time evolution path generated based on the calculation condition parameters sampled from the posterior probability distribution is below a target error.

### INCORPORATION BY REFERENCE

This application claims priority based on Japanese patent application, No. 2025-59021 filed on Mar. 31, 2025, the entire contents of which are incorporated herein by reference.

### BACKGROUND OF THE INVENTION

### Field of the Invention

The present invention relates to a computer, a time evolution path generation method, and a time evolution path generation program.

### Description of the Related Art

There is a technique called data assimilation, which estimates current and future states of a complicated system based on observation and simulation of the system. In the data assimilation, uncertainty of initial conditions, boundary conditions, and model parameters of the system is typically considered as a probability distribution when time evolution of the probability distribution of the system state is simulated.

As one method of simulating time evolution of a probability distribution of a system state, there is Monte Carlo simulation in which a plurality of samples are extracted from a probability distribution of uncertain parameters and simulation of time evolution is executed for each sample. Since the Monte Carlo simulation requires the amount of calculation of O(1/ε²) to reduce an error to & times, the amount of calculation becomes huge.

For example, Non-Patent Literature 1 discloses a method of simulating, by a quantum computer, time evolution of a probability distribution of a system state using the Koopman-von Neumann (KvN) formulation. According to Non-Patent Literature 1, it is possible to simulate nonlinear and non-Hamiltonian classical dynamics with the quantum computer by using the generalized KvN formulation. Also, Non-Patent Literature 2 discloses that squaring efficiency is improved as compared with the classical Monte Carlo simulation, by using amplitude estimation.

In other words, it is possible to reduce an error to ε times with the amount of calculation of O(1/ε) by using the method disclosed in Non-Patent Literature 1 and the amplitude estimation disclosed in Non-Patent Literature 2 in combination.

### CITATION LIST

### Non-Patent Literature

Non-Patent Literature 1: Ilon Joseph, Koopman-von Neumann approach to quantum simulation of nonlinear classical dynamics, [online], PHYSICAL REVIEW RESEARCH 2, 043102 (2020), [searched on Jan. 23, 2025], the Internet
Non-Patent Literature 2: Ashley Montanaro, Quantum speedup of Monte Carlo methods, [online], Proceedings of The Royal Society Series A, vol. 471 no. 2181, 20150301, 2015, [searched on Jan. 23, 2025], the Internet

### SUMMARY OF THE INVENTION

However, it is only possible to obtain information on specific statistics (for example, an average value of certain state variables in the system) at a certain time in the future even if the method disclosed in Non-Patent Literature 1 and the method disclosed in Non-Patent Literature 2 are combined. In other words, there is room for improvement in a simulation method to obtain an arbitrary statistic at a high speed in simulation of time evolution of a probability distribution of state variables in the system, similarly to the Monte Carlo simulation.

The present invention was made in consideration of the above-mentioned circumstances, and one object thereof is to obtain an arbitrary statistic at a high speed in simulation of time evolution of a probability distribution of state variables in a system.

In order to achieve the above object, an aspect of the present invention provides a computer that generates a time evolution path representing time evolution of a system in time-series variables, the computer including a processor, the processor being configured to calculate, based on a time evolution model that models the time evolution, a correct statistic that indicates a value that a target statistic based on the variables related to the time evolution path is to take at a target time for the target statistic, sample calculation condition parameters designating calculation conditions for the time evolution path from a prior probability distribution of the calculation condition parameters, generate a first time evolution path based on the calculation condition parameters sampled from the prior probability distribution and the time evolution model, assume a second time evolution path to be newly generated and calculate a posterior probability distribution of the calculation condition parameters in a case where the target statistic based on the first time evolution path and the second time evolution path is the correct statistic, sample the calculation condition parameters from the posterior probability distribution such that an error between the correct statistic and the target statistic based on the second time evolution path generated based on the calculation condition parameters sampled from the posterior probability distribution is below a target error, and generate the second time evolution path based on the calculation condition parameters sampled from the posterior probability distribution and the time evolution model.

According to the present invention, it is possible to obtain an arbitrary statistic at a high speed in simulation of time evolution of a probability distribution of state variables in a system, for example.

### BRIEF DESCRIPTION OF THE DRAWINGS

FIG. 1 is a block diagram illustrating a functional configuration example of a probabilistic scenario generation apparatus;

FIG. 2 is an explanatory diagram illustrating an example of weather scenarios;

FIG. 3A is an explanatory diagram illustrating an example in which a new weather scenario is sampled;

FIG. 3B is an explanatory diagram illustrating the example in which the new weather scenario is sampled;

FIG. 4 is an explanatory diagram illustrating a data structure example of a calculation condition parameter DB;

FIG. 5 is an explanatory diagram illustrating a data structure example of a time evolution path DB;

FIG. 6 is an explanatory diagram illustrating a data structure example of a statistic DB;

FIG. 7 is a flowchart illustrating a probabilistic scenario generation processing procedure example;

FIG. 8 is an explanatory diagram illustrating an example of a user interface of an input unit;

FIG. 9 is an explanatory diagram illustrating an example of a user interface of an output unit; and

FIG. 10 is a block diagram illustrating an example of hardware of a computer.

### DETAILED DESCRIPTION OF THE INVENTION

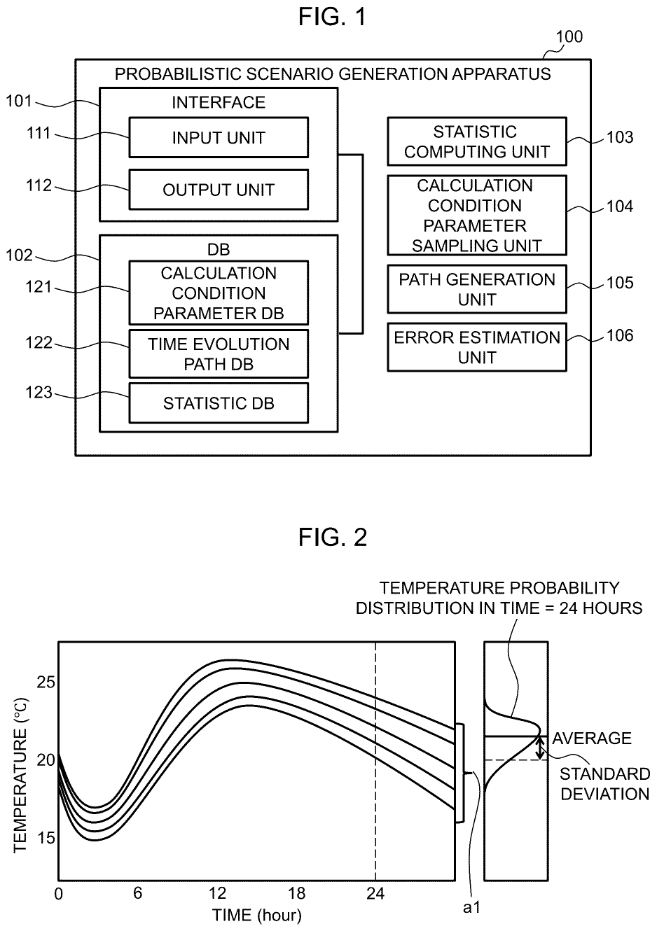

Hereinafter, an embodiment according to the present invention will be described in detail with reference to FIGS. 1 to 9. Note that the present invention is not limited by the following embodiment.

In the present embodiment, an example in which a time evolution path (weather scenario) sampled from a prior probability distribution of calculation condition parameters is generated using the Monte Carlo simulation will be described. Here, the calculation condition parameters are parameters for designating calculation conditions for the time evolution path, such as parameters of initial conditions, boundary conditions, and a weather time evolution model.

The present embodiment is effective in a case where a weather in several hours is predicted from an image captured by a weather satellite, for example. An effect of reducing calculation resources for accurate weather forecast and power consumption required by the calculation resources and the like are expected by gradually reducing the number of necessary repetitions of Monte Carlo simulation by a particle filter, which is one of data assimilation methods, for example, using the present embodiment.

Note that although the example in which a weather scenario is generated will be described in the present embodiment, it is possible to apply the present invention to a system in which a time evolution model can be expressed by a differential equation, in the Hamilton formulation, in the Lagrange formulation, or the like, like human flow simulation, as well as weathers.

FIG. 1 is a block diagram illustrating a functional configuration example of a probabilistic scenario generation apparatus 100.

The probabilistic scenario generation apparatus 100 includes an interface 101, a database (DB) 102, a statistic computing unit 103, a calculation condition parameter sampling unit 104, a path generation unit 105, and an error estimation unit 106.

The interface 101 includes an input unit 111 and an output unit 112. The input unit 111 is adapted such that data including a target statistic and a target error is input thereto. The input unit 111 may be adapted such that a function of a prior distribution of calculation condition parameters is similarly input thereto.

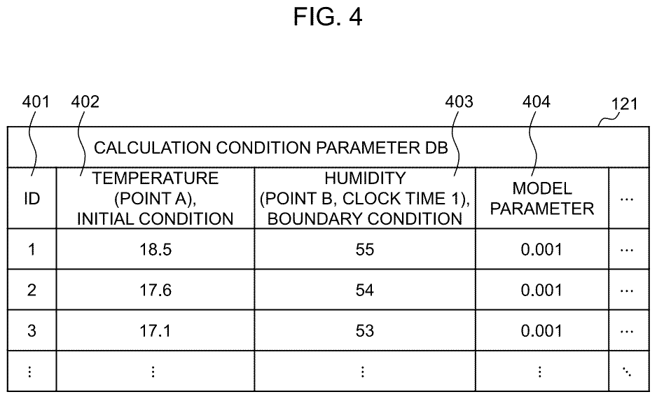

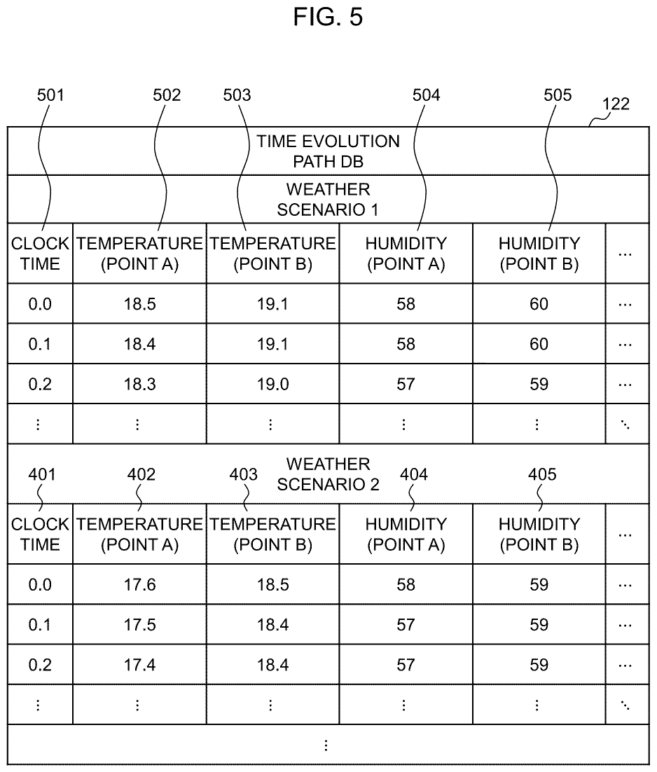

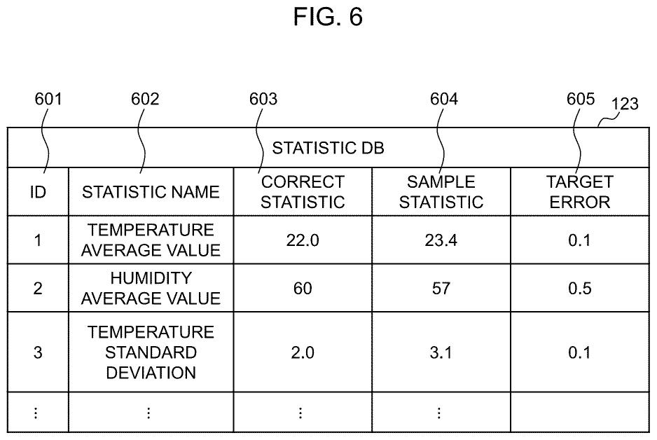

The DB 102 includes a calculation condition parameter DB 121 (FIG. 4), a time evolution path DB 122 (FIG. 5), and a statistic DB 123 (FIG. 6).

The statistic computing unit 103 estimates a correct statistic of the designated target statistic for the prior distribution of the calculation condition parameters and stores the correct statistic in the statistic DB 123. The statistic computing unit 103 is configured of a quantum computer or a quantum arithmetic device.

The calculation condition parameter sampling unit 104 samples calculation condition parameters from a prior distribution of calculation condition parameters input from the input unit 111 or a posterior distribution of calculation condition parameters, which will be described later, and stores the calculation condition parameters in the calculation condition parameter DB 121.

The path generation unit 105 generates a weather scenario by solving a time evolution model such as a differential equation describing weather time evolution and stores the weather scenario in the time evolution path DB 122. The error estimation unit 106 calculates a sample statistic, which will be described later, from the weather scenario stored in the time evolution path DB 122 and calculates an error for the correct statistic stored in the statistic DB 123.

Note that in the probabilistic scenario generation apparatus 100, the statistic computing unit 103 is configured of a quantum computer or a quantum arithmetic device, and not only the statistic computing unit 103 but also other processing units may also be configured of quantum computers or quantum arithmetic devices. Alternatively, the probabilistic scenario generation apparatus 100 may be configured such that the statistic computing unit 103 performs computing of a statistic using calculation resources of an external quantum computer or quantum arithmetic device connected thereto via a network.

FIG. 2 is an explanatory diagram illustrating an example of weather scenarios.

FIG. 2 illustrates time evolution of temperature at a certain point as a representative example among various kinds of obtained weather information and illustrates five weather scenarios a1. In the present embodiment, a case where it is desired to converge several statistics (referred to as “target statistics”) at a target time, for example, 24 hours later at a high speed will be considered. Here, the target statistics can be represented in a real-valued function form as Expression (1) using an expected value of a function f1(X), . . . , fn(X) (n is an arbitrary natural number) of a random variable X.

$$[ Expression 1 ]$$

$$g ( 𝔼 [ {f}_{1} ( X ) ] , … , 𝔼 [ {f}_{n} ( X ) ] ) … \qquad ( 1 )$$

Specific examples of the target statistics include an average value of the random variable X represented by Expression (2) and a standard deviation of the random variable X represented by Expression (3).

$$[ Expression 2 ]$$

$$𝔼 [ X ] … \qquad ( 2 )$$

$$[ Expression 3 ]$$

$$\sqrt{𝔼 [ {X}^{2} ] - {𝔼 [ X ]}^{2}} … \qquad ( 3 )$$

The target statistics are designated by a user, and the user can designate one or more, which may be an arbitrary number, of target statistics. Also, all the target statistics may not necessarily be values at the same time, and it is possible to handle various statistics at various times, such as an average value of temperatures at a time t1 and a standard deviation of humidities at a time t2, for example, as target statistics at the same time.

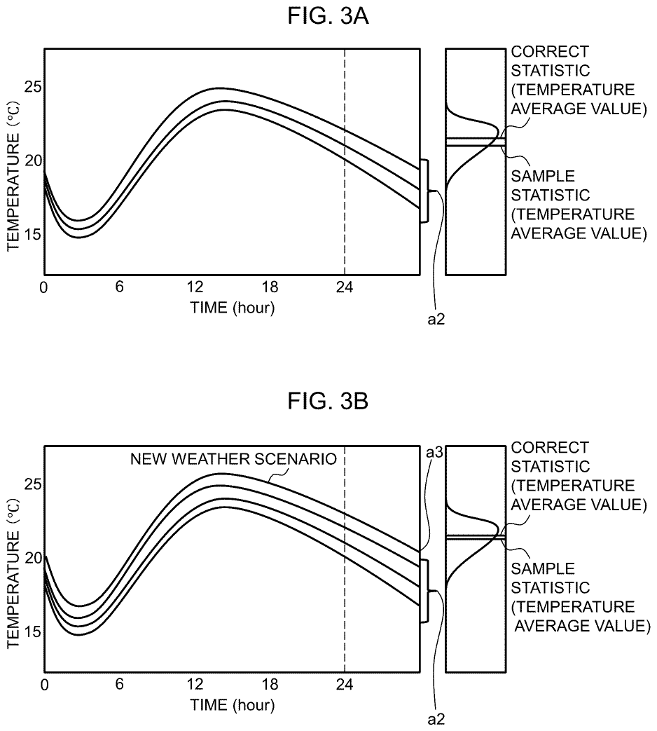

FIGS. 3A and 3B are explanatory diagrams illustrating an example in which a new weather scenario is sampled.

FIG. 3A illustrates that three weather scenarios a2 have already been obtained through weather simulation. FIG. 3B illustrates that target statistics (sample statistics) have approached a correct statistic as compared with FIG. 3A by another new weather scenario a3 being sampled in addition to the three weather scenarios a2 in FIG. 3A. In this manner, it is possible to perform next sampling of the weather scenarios that allow the target statistics to converge to a true value at a high speed by the following procedure in the present embodiment. However, FIGS. 3A and 3B illustrate just an example, the number of weather scenarios that have already been obtained may be any number, and the number of weather scenarios of the next sampling may also be any number.

First, the statistic computing unit 103 computes a target statistic at a target time. According to Non-Patent Literature 1, a time evolution model of a vector x(t) representing a weather state at a time t is represented as Expression (4) using a vector value function v(x).

$$\begin{matrix}[ Expression 4 ] & \\ \frac{dx}{dt} = v ( x ) & ( 4 )\end{matrix}$$

At this time, if a canonical conjugate momentum P of the vector x is introduced, KvN Hamiltonian H(x, P) is represented as Expression (5).

$$\begin{matrix}[ Expression 5 ] & \\ ℋ ( x , P ) = \frac{1}{2} ( P \cdot v ( x ) + v ( x ) \cdot P ) & ( 5 )\end{matrix}$$

A probability distribution p(t, x) at the time t is obtained as Expression (6) using a wave function φ(t, x) of a quantum system described by KvN Hamiltonian H (x, P) (Koopman-von Neumann formulation).

$$\begin{matrix}[ Expression 6 ] & \\ p ( t , x ) = {\vert ψ ( t , x ) \vert}^{2} & ( 6 )\end{matrix}$$

The time evolution of the quantum system can be computed by discretizing x to encode it into qubits and then implementing a time evolution operator with a quantum circuit using Suzuki-Trotter decomposition, for example. Furthermore, it is possible to estimate the target statistic at a higher speed as compared with the case where Monte Carlo simulation is performed, by computing an expected value represented by Expression (7) using an amplitude estimation algorithm as described in Non-Patent Literature 2, for example, on a quantum state at a target time at which it is desired to obtain the target statistic. The target statistic obtained here will be referred to as a correct statistic.

$$\begin{matrix}[ Expression 7 ] & \\ 𝔼 [ {f}_{i} ( x ( t ) ) ] & ( 7 )\end{matrix}$$

The correct statistic obtained here is just a value of a specific statistic at a specific time, and it is not possible to know a probability distribution of temperatures at other times, for example, only from this information. Thus, weather scenarios are sampled by a method of converging them to the correct statistic at a high speed in the present embodiment. It is thus possible to obtain a weather scenario that is accurate at least in regard to the target statistic regardless of the small number of samples.

In the present embodiment, it is assumed that a prior probability distribution p(c) of calculation condition parameters c can be sampled, and the target statistic will be represented by a vector value function as Expression (8).

$$\begin{matrix}[ Expression 8 ] & \\ g ( {𝔼}_{c ∼ p} [ f ( c ) ] ) & ( 8 )\end{matrix}$$

Here, an m-th component of the vector value function f(c) in Expression (8) is given by Expression (9). Expression (9) is obtained by explicitly writing only c dependency. Tm is a target time of the target statistic designated by the user and may be a time that differs in accordance with m as described above.

$$\begin{matrix}[ Expression 9 ] & \\ {f}_{m} ( x ( {T}_{m} , c ) ) & ( 9 )\end{matrix}$$

A sample group of weather scenarios that have already been obtained is defined as S0, and a sample group of weather scenarios to be sampled next is defined as S1. The numbers |S0| and |S1| of the weather scenarios included in S0 and S1 may be arbitrary numbers.

At this time, the target statistic represented as Expression (10) based on the expected value calculated using the sample group S will be referred to as a “sample statistic using S”.

$$\begin{matrix}[ Expression 10 ] & \\ {g}_{S} := g ( \frac{1}{\vert S \vert} {\sum }_{s ∈ S} f ( {c}_{s} ) ) & ( 10 )\end{matrix}$$

Here, cₛ is a calculation condition parameter of a sample s∈S. Also, f(cₛ) is the vector value function f(c) (Expression (8)) calculated using a weather scenario x(t, cₛ) at the calculation condition parameter of the sample s∈S.

A goal in the present embodiment is to obtain a posterior probability distribution when a sample statistic g_{S0∪S1} using all samples S0∪S1 is defined as a correct statistic g* for a new calculation condition parameter group C₁. Also, the goal is to sample the calculation condition parameter group C₁ from the posterior probability distribution. The calculation condition parameter group C₁ is defined by Expression (11). Also, the posterior probability distribution is represented by Expression (12).

$$\begin{matrix}[ Expression 11 ] & \\ {C}_{1} := {\{ {c}_{s} \}}_{s ∈ {S}_{1}} & ( 11 )\end{matrix}$$

$$\begin{matrix}[ Expression 12 ] & \\ p ( {C}_{1} \vert {g}_{{S}_{0} ⋃ {S}_{1}} = {g}^{*} ) ∝ p ( {g}_{{S}_{0} ⋃ {S}_{1}} = {g}^{*} \vert {C}_{1} ) p ( {C}_{1} ) & ( 12 )\end{matrix}$$

The sampling of the calculation condition parameter group C₁ from the posterior probability distribution of Expression (12) is performed as follows. p(C₁) can be written as Expression (13). Sampling of the calculation condition parameter group C₁ from Expression (13) is possible.

$$\begin{matrix}[ Expression 13 ] & \\ p ( {C}_{1} ) = {\prod }_{s ∈ {S}_{1}} p ( {c}_{s} ) & ( 13 )\end{matrix}$$

Therefore, if the value of the right side p(g_{S0∪S1}=g*|C₁) in Expression (12) is known, it is possible to sample C₁ from the posterior probability distribution of Expression (12) through sampling importance resampling using this value as a weight, for example.

Thus, p g_{S0∪s1}=g*|C₁) is modeled using a weather scenario {x(t, cₛ)}_{s∈S} that has already been obtained. Examples of the modeling method include the following two methods.

The first method is a method of modeling p(f(c)|c) by Gaussian process regression using the correspondence between cₛ and f(cₛ) of each weather scenario {x(t, cₛ)}_{s∈S} that has already been obtained. In this manner, it is possible to sample {f(cₛ)}_{s∈S1} from C₁. Also, it is possible to calculate g_{S0∪S1} from {f(cₛ)}_{s∈S0} and {f(cₛ)}_{s∈S1} based on the definition and to thereby model p(g_{S0∪S1}=g*|C₁) by {f(cₛ)}_{s∈S1} sampled a plurality of times using, for example, kernel density estimation.

The second method is a method of deterministically modeling an approximation function f(c) ~ of f(c) using, for example, polynomial regression or a neural network from the correspondence between cₛ and f (cₛ) of each weather scenario {x(t, cₛ)} that has already been obtained. In this method, p(g_{S0∪S1}=g*|C₁) is modeled using an exponential distribution L represented by Expression (14). Note that “A~” is synonymous with the symbol “~” added right above the symbol A.

$$\begin{matrix}[ Expression 14 ] & \\ p ( {g}_{{S}_{0} ⋃ {S}_{1}} \vert {C}_{1} ) ∝ {e}^{- βℒ} & ( 14 )\end{matrix}$$

$$ℒ = ‖ {g}_{{S}_{0} ⋃ {S}_{1}} - g ( \frac{1}{\vert {S}_{0} \vert + \vert {S}_{1} \vert} [ {\sum }_{s ∈ {S}_{0}} f ( {c}_{s} ) + {\sum }_{s ∈ {S}_{1}} \tilde{f} ( {c}_{s} ) ] ) ‖$$

It is possible to sample C₁ from p(C₁|g_{S0∪S1}=g*) by the above methods, and it is possible to obtain the weather scenario {x(t, cₛ)}_{s∈S} in which the target statistic converges with a true value at a high speed by solving a weather time evolution model for C₁.

The above-mentioned sampling procedures are just examples. Even in a case where the system time evolution model is not given as a differential equation, and only Hamiltonian is given, for example, it is possible to perform conversion into KdV Hamiltonian by the method described in Non-Patent Literature 1 and to apply a similar procedure.

FIG. 4 is an explanatory diagram illustrating a data structure example of the calculation condition parameter DB 121.

The calculation condition parameter DB 121 is a table that stores calculation condition parameters of each weather scenario and stores, as column values, weather scenario IDs 401 and calculation condition parameters associated with the weather scenario IDs 401. The calculation condition parameters are, for example, actual values representing initial conditions such as temperature (point A) initial conditions 402, actual values representing boundary conditions such as humidity (point B, time 1) boundary conditions 403, or actual values representing model parameters such as model parameters 404.

FIG. 5 is an explanatory diagram illustrating a data structure example of the time evolution path DB 122.

The time evolution path DB 122 has a three-dimensional data structure storing time evolution of each variable of each weather scenario. In other words, the time evolution path DB 122 represents time evolution of a target system in time series of each variable indicating each state of the target system.

For each weather scenario, a time 501 and state variables associated with the time 501 are stored as column values. The state variables are actual values corresponding to each time 501, for example, a temperature (point A) 502, a temperature (point B) 503, a humidity (point A) 504, and a humidity (point B) 505, the number of state variables is not limited, and there may also be missing values.

FIG. 6 is an explanatory diagram illustrating a data structure example of the statistic DB 123.

The statistic DB 123 is a table that stores values related to the target statistic and stores, as column values, statistic IDs 601, and statistic names 602, correct statistics 603, sample statistics 604, and target errors 605 associated with the statistic IDs 601. All the columns are not necessarily needed, and it is also possible to omit, for example, the statistic names 602 or the target errors 605.

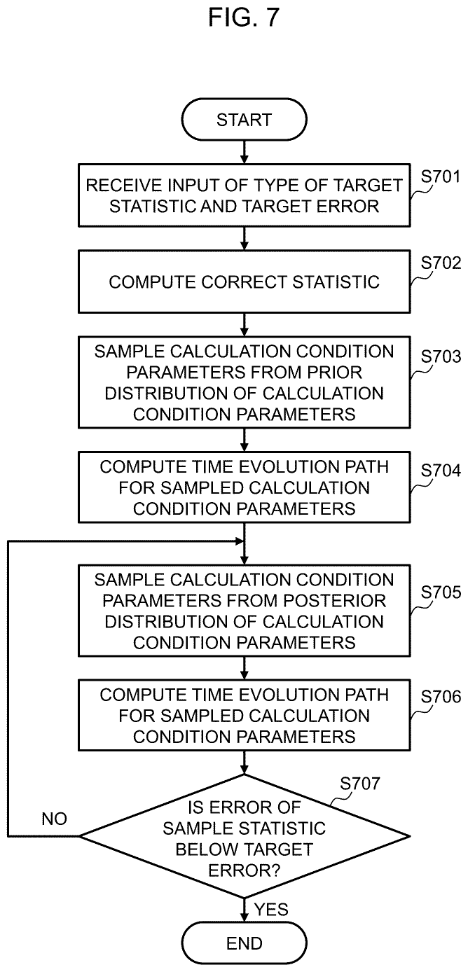

FIG. 7 is a flowchart illustrating a probabilistic scenario generation processing procedure example. A time evolution path generation program implements at least one or more processes described below by being read from a storage resource and being executed by a processor.

### Step S701

### Data Input Receiving Processing

The probabilistic scenario generation apparatus 100 receives an input of data including the type (statistic name) of the target statistic and the target error by the input unit 111 and moves on to Step S702. The type (statistic name) of the target statistic and the target error are stored in the statistic DB 123.

### Step S702

### Correct Statistic Computing Processing

The probabilistic scenario generation apparatus 100 computes the correct statistic by the statistic computing unit 103 and moves on to Step S703. The correct statistic is stored in the statistic DB 123.

### Step S703

Sampling Processing from Prior Distribution of Calculation Condition Parameters

The probabilistic scenario generation apparatus 100 samples the calculation condition parameters from the prior distribution of the calculation condition parameters by the calculation condition parameter sampling unit 104 and moves on to Step S704. The sampled calculation condition parameters are stored in the calculation condition parameter DB 121.

### Step S704

### First Time Evolution Path Computing Processing

The probabilistic scenario generation apparatus 100 generates a weather scenario for the calculation condition parameters sampled in Step S703 by the path generation unit 105 and moves on to Step S705. The generated weather scenario is stored in the time evolution path DB 122.

### Step S705

Sampling Processing from Posterior Distribution of Calculation Condition Parameters

The probabilistic scenario generation apparatus 100 samples the calculation condition parameters from the posterior distribution of the calculation condition parameters obtained using the time evolution path DB 122 by the calculation condition parameter sampling unit 104 and moves on to Step S706. The sampled calculation condition parameters are stored in the calculation condition parameter DB 121.

### Step S706

### Second Time Evolution Path Computing Processing

The probabilistic scenario generation apparatus 100 generates a weather scenario based on the calculation condition parameters sampled in Step S705 and the time evolution model by the path generation unit 105 and moves on to Step S707. The generated weather scenario is stored in the time evolution path DB 122.

### Step S707

### Error Determination Processing

The probabilistic scenario generation apparatus 100 calculates a sample statistic using the weather scenario stored in the time evolution path DB 122 and stores the sample statistic in the statistic DB 123. The error estimation unit 106 calculates an error for each statistic from the correct statistic 603 and the sample statistic 604 stored in the statistic DB 123, and returns to Step S705 if the error is not below the target error 605, or ends the probabilistic scenario generation processing if the error is below the target error 605.

The processing described hitherto is processing implemented by the time evolution path generation program. The above-mentioned generation processing procedure is just an example, and satisfaction of a preset number of repetition may be used as an end condition instead of using the fact that the error calculated by the error estimation unit 106 is below the target error 605 as the end condition in Step S707, for example.

For example, Steps S703 and S704 are executed using Monte Carlo simulation to generate a plurality of time evolution paths. Then, Steps S705 to S707 are executed using the method of generating the time evolution path of the present embodiment based on Expressions (8) to (14) described above, thereby obtaining a weather scenario converging at a high speed.

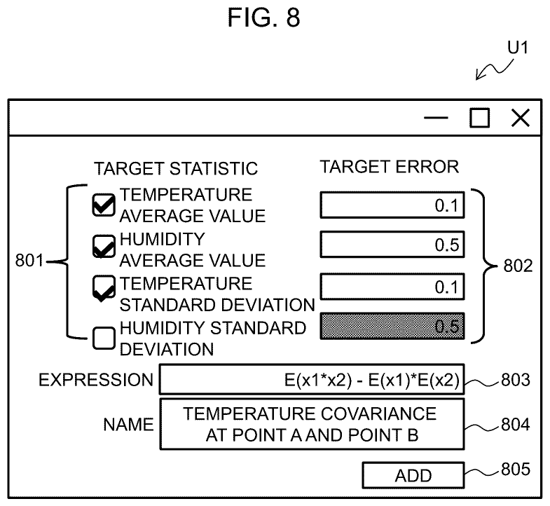

FIG. 8 is an explanatory diagram illustrating an example of an input user interface U1 of the input unit 111. The input user interface U1 is configured to include check boxes 801, text boxes 802, input boxes 803 and 804, and an add button 805.

The check boxes 801 are for selecting whether the corresponding target statistics are to be used, and utilization of the corresponding target statistics is selected by checking the boxes. The text boxes 802 are for inputting target errors of the corresponding target statistics.

The input boxes 803 and 804 are for adding an expression (definition) and a name of a new target statistic. A numerical formula of the target statistic is input to the input box 803, and the name is input to the input box 804. If the add button 805 is pressed, a check box 801 and a text box 802 corresponding to “temperature covariance between point A and point B”, for example, are added to the target statistic group displayed on the screen.

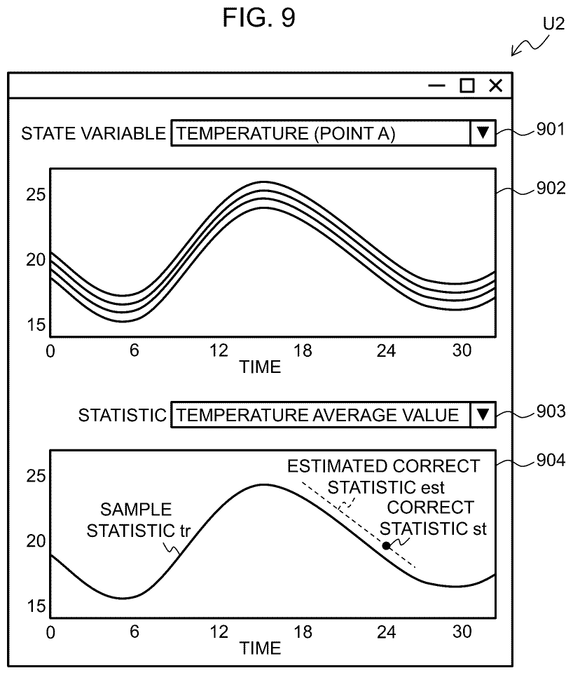

FIG. 9 is an explanatory diagram illustrating an example of an output user interface U2 of the output unit 112. The output user interface U2 is configured to include a state variable selection pull-down menu 901, a state variable display section 902, a statistic selecting section 903, and a statistic display section 904.

The state variable selection pull-down menu 901 is operated by the user, and a corresponding state variable of a weather scenario is selected. The selected state variable is read from the time evolution path DB 122 and displayed as a time-series graph in the state variable display section 902.

Also, the statistic selecting section 903 is operated by the user, and a corresponding statistic of the weather scenario is selected. The sample statistic and the correct statistic for the selected statistic stored in the statistic DB 123 are displayed as a time-series graph in the statistic display section 904.

At this time, not only the target statistic calculated using the value x at the time Im given by Expressions (9) and (10) but also the sample statistic shifted by t to another time at which the m-th component is defined as in Expression (15) are calculated as the sample statistic. The temporal trajectory of the sample statistic tr may be displayed as in FIG. 9.

$$\begin{matrix}[ Expression 15 ] & \\ {f}_{m} ( x ( {T}_{m} + t , c ) ) & ( 15 )\end{matrix}$$

In regard to the correct statistic st, not only the correct statistic st at the time Tm given by Expressions (9) and (10) but also the correct statistic st defined by Expressions (8) and (15) shifted to other times may be estimated within a range in which an absolute value of the shift time t from the time Tm is small. The estimation result may be regarded as an estimated correct statistic est and may be displayed as in FIG. 9. The estimation method is as follows.

In other words, the correct statistic st at a shifted time can be represented by Taylor-expanding up to the first order term for the shift time t as in Expression (16).

$$\begin{matrix}[ Expression 16 ] & \\ g ( {𝔼}_{c ∼ p} [ f ( c ) ] ) + V \cdot ∇ g ( {𝔼}_{c ∼ p} [ f ( c ) ] ) t & ( 16 )\end{matrix}$$

Here, the m-th component of V in Expression (16) is given by Expression (17).

$$\begin{matrix}[ Expression 17 ] & \\ {V}_{m} = {𝔼}_{c ∼ p} [ v ( x ( {T}_{m} , c ) ) \cdot {∇}_{x} {f}_{m} ( x ( {T}_{m} , c ) ) ] & ( 17 )\end{matrix}$$

Here, V can be calculated at a higher speed by performing approximation as in Expression (17) using a sample group S that has been obtained than by calculating it using the statistic computing unit 103.

$$\begin{matrix}[ Expression 18 ] & \\ {V}_{m} \approx \frac{1}{\vert S \vert} {\sum }_{s ∈ S} v ( x ( {T}_{m} , {c}_{s} ) ) \cdot {∇}_{x} {f}_{m} ( x ( {T}_{m} , c ) ) & ( 18 )\end{matrix}$$

Expression (16) giving the estimated correct statistic est has high accuracy within a range in which the absolute value of the shift time t is sufficiently small, and an error err increases as the absolute value of the shift time t increases. The error err is considered to be substantially equal to a difference between the sample statistic tr at a shifted time and first-order approximation for the shift time t as represented by Expression (19).

$$\begin{matrix}[ Expression 19 ] & \\ g ( \frac{1}{\vert S \vert} {\sum }_{s ∈ S} f ( {c}_{s} ) ) + V \cdot ∇ g ( \frac{1}{\vert S \vert} {\sum }_{s ∈ S} f ( {c}_{s} ) ) t & ( 19 )\end{matrix}$$

Thus, it is possible to indicate the estimated correct statistic est only within a range in which accuracy is secured to some extent, by displaying the estimated correct statistic est in the statistic display section 904 only within a predetermined range of a target time in which the absolute value of the error err is smaller than a preset threshold value.

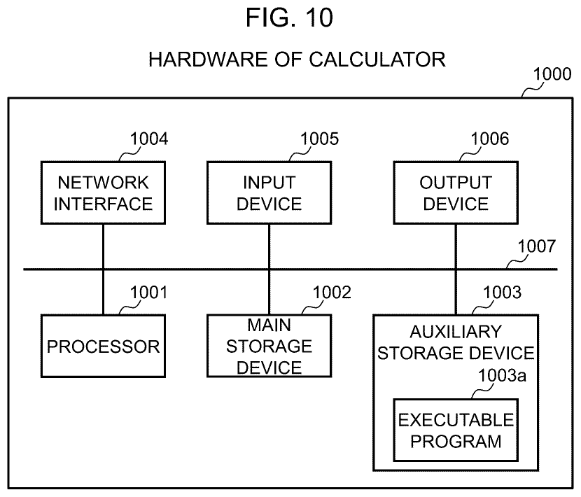

FIG. 10 is a block diagram illustrating an example of hardware of a computer 1000.

The computer 1000 is an on-premises or cloud calculation resource that realizes each component of the probabilistic scenario generation apparatus 100 by executing a predetermined program. The probabilistic scenario generation apparatus 100 is constructed by one or more computers 1000.

The computer 1000 includes a processor 1001, a main storage device 1002, an auxiliary storage device 1003, a network interface 1004, an input device 1005, and an output device 1006 which are connected to each other via an internal communication line 1007 such as a bus.

The processor 1001 is any of various semiconductor devices, such as a CPU or a GPU, that is in charge of overall operation control of the computer 1000. The main storage device 1002 is configured of a volatile semiconductor memory, for example, and is used as a work memory of the processor 1001. The auxiliary storage device 1003 is configured of a large-capacity non-volatile storage device such as a hard disk device, a solid state drive (SSD), or a flash memory and is used to hold various programs and data for a long period of time.

Executable programs 1003a stored in the auxiliary storage device 1003 are loaded on the main storage device 1002 when the computer 1000 is activated or as needed, and are executed by the processor 1001.

Note that the executable programs 1003a may be recorded in a non-transitory recording medium, may be read by a medium reading device from the non-transitory recording medium, and may be loaded on the main storage device 1002. Alternatively, the executable programs 1003a may be acquired from an auxiliary storage device of an external computer via a network and may be loaded on the main storage device 1002.

The auxiliary storage device 1003 stores various executable programs 1003a. Note that the main storage device 1002 and the auxiliary storage device 1003 may be collectively referred to as a memory.

The network interface 1004 is an interface device for connecting the computer 1000 to each network in the system or for communicating with other computers. The network interface 1004 is configured of, for example, a network interface card (NIC) of a wired local area network (LAN), a wireless LAN, or the like.

The input device 1005 is configured of keyboard, a pointing device such as a mouse, and the like and is used by the user to input various instructions and information to the computer 1000. The output device 1006 is configured of, for example, a display device such as a liquid crystal display or an organic electro luminescence (EL) display and an audio output device such as a speaker and is used to present necessary information to the user as needed.

### Effect of Embodiment

In the above-mentioned embodiment, the probabilistic scenario generation apparatus 100 generates first time evolution path based on calculation condition parameters sampled from a prior probability distribution of calculation condition parameters and a time evolution model. Then, the probabilistic scenario generation apparatus 100 calculates a posterior probability distribution of the calculation condition parameters in a case where a target statistic based on the first time evolution path and a second time evolution path that is assumed and is newly generated is a correct statistic indicating a value that the target statistic should be at a target time. Then, the probabilistic scenario generation apparatus 100 samples the calculation condition parameters from the posterior probability distribution such that an error between the correct statistic and the target statistic based on the second time evolution path is below a target error. The second time evolution path is a time evolution path generated based on the calculation condition parameters sampled from the posterior probability distribution. Then, the probabilistic scenario generation apparatus 100 generates the second time evolution path based on the calculation condition parameters sampled from the posterior probability distribution and the time evolution model.

Therefore, according to the present embodiment, it is possible to obtain a target statistic at a target time at a high speed in simulation of time evolution of a probability distribution of system state variables. Also, according to the present embodiment, it is possible to obtain a probability distribution of a system state at an arbitrary time and a target statistic at a target time at a high speed and with high accuracy even in a case where the number of samples of the calculation condition parameters is small.

Also, in the above-mentioned embodiment, the probabilistic scenario generation apparatus 100 calculates the correct statistic using a quantum arithmetic device. Moreover, in the above-mentioned embodiment, the correct statistic is calculated using the Koopman-von Neumann formulation and the qubit amplitude estimation. Therefore, according to the present embodiment, it is possible to estimate the correct statistic at a higher speed as compared with a case where the Monte Carlo simulation is used.

In the above-mentioned embodiment, the probabilistic scenario generation apparatus 100 models the posterior probability distribution of the calculation condition parameters using the first time evolution path that has already been generated and a Gaussian process or Expression (14). Therefore, according to the present embodiment, it is possible to execute the sampling of the calculation condition parameters from the posterior probability distribution of the calculation condition parameters through sampling importance resampling using the right side p(g_{S0∪S1}=g*|C₁) in Expression (12) described above as a weight.

Also, in the above-mentioned embodiment, the probabilistic scenario generation apparatus 100 repeatedly samples the calculation condition parameters from the posterior probability distribution of the calculation condition parameters until the error between the correct statistic and the target statistic becomes below the target error. Therefore, according to the present embodiment, it is possible to quickly perform sampling of the calculation condition parameters and generation of the second time evolution path by using the method of the present embodiment based on Expressions (8) to (14) described above at the time of the sampling of the calculation condition parameters regarding error determination. Therefore, it is possible to converge the simulation of the time evolution at a high speed even in a case where a strict numerical value is set as a target error and the number of sampling trials increases, and it is thus possible to obtain a probability distribution of a system state at an arbitrary time and a target statistic at a target time at a high speed and with high accuracy.

In the above-mentioned embodiment, a true value of the correct statistic within a predetermined range of a target time is estimated based on the correct statistic and the target statistic based on the second time evolution path. Therefore, according to the present embodiment, it is possible to calculate the true value of the correct statistic (estimated correct statistic) at a high speed within a range in which accuracy is secured.

In the above-mentioned embodiment, user input of a type of a target statistic and a target error are received via the input user interface. Also, in the above-mentioned embodiment, the correct statistic, the first time evolution path, the second time evolution path, the target statistic based on the first time evolution path, the target statistic based on the second time evolution path, the true value of the correct statistic within the predetermined range of the target time, or the calculation condition parameters are output via the output user interface. Therefore, according to the present embodiment, the user can cause simulation of time evolution of a probability distribution of system state variables to be executed merely by designating the type of the target statistic and the target error and can obtain GUI display of various statistics, various time evolution paths, and calculation condition parameters.

The present invention is not limited to the above-mentioned embodiment and include a variety of modifications. For example, the above-mentioned embodiment has given detailed description for easy understanding of the present invention, and the present invention is not necessarily limited to embodiments including all the described configurations. Also, some of configurations in a certain embodiment may be replaced with configurations in other embodiments, and it is also possible to add, to configurations in a certain embodiment, configurations in other embodiments. For some of configurations in each embodiment, addition, deletion, and replacement of other configurations can be made. Some or all of the above-mentioned configurations, functions, processing units, processing means, and the like may be implemented as hardware by designing them as an integrated circuit, for example. Also, the above-mentioned configurations, functions, and the like may be implemented in software by a processor interpreting and executing a program implementing the functions thereof.

Reference Signs List

What is claimed is:

1. A computer that generates a time evolution path representing time evolution of a system in time-series variables, comprising:
a processor,
wherein the processor is configured to
calculate, based on a time evolution model that models the time evolution, a correct statistic that indicates a value that a target statistic based on the variables related to the time evolution path is to take at a target time for the target statistic,
sample calculation condition parameters designating calculation conditions for the time evolution path from a prior probability distribution of the calculation condition parameters,
generate a first time evolution path based on the calculation condition parameters sampled from the prior probability distribution and the time evolution model,
assume a second time evolution path to be newly generated and calculate a posterior probability distribution of the calculation condition parameters in a case where the target statistic based on the first time evolution path and the second time evolution path is the correct statistic,
sample the calculation condition parameters from the posterior probability distribution such that an error between the correct statistic and the target statistic based on the second time evolution path generated based on the calculation condition parameters sampled from the posterior probability distribution is below a target error, and
generate the second time evolution path based on the calculation condition parameters sampled from the posterior probability distribution and the time evolution model.

2. The computer according to claim 1,
wherein the processor calculates the correct statistic using a quantum arithmetic device.

3. The computer according to claim 2,
wherein the processor calculates the correct statistic using a Koopman-von Neumann formulation and qubit amplitude estimation.

4. The computer according to claim 1,
wherein the processor models the posterior probability distribution using the first time evolution path.

5. The computer according to claim 1,
wherein the processor repeatedly samples the calculation condition parameters from the posterior probability distribution until the error becomes below the target error.

6. The computer according to claim 5,
wherein the processor estimates a true value of the correct statistic within a predetermined range of the target time based on the correct statistic and the target statistic based on the second time evolution path.

7. The computer according to claim 5,
wherein the processor receives user input of a type of the target statistic and the target error via an input user interface.

8. The computer according to claim 6,
wherein the processor outputs the correct statistic, the first time evolution path, the second time evolution path, the target statistic based on the first time evolution path, the target statistic based on the second time evolution path, the true value of the correct statistic within the predetermined range of the target time, or the calculation condition parameters via an output user interface.

9. A time evolution path generation method comprising:
performing each process executed by the computer according to claim 1.

10. A time evolution path generation program that causes a computer to function as the computer according to claim 1.
